(19) United States
(12) Patent Application Publication
(10) Pub. No.: US 2020/0279465 A1
(43) Pub. Date: Sep. 3, 2020

(54) SYSTEM AND METHOD FOR WEARABLE TECHNOLOGY

(71) Applicant: Kimberly A. GAVIN, Manhasset, NY (US)

(72) Inventor: Kimberly A. GAVIN, Manhasset, NY (US)

(21) Appl. No.: 15/781,004

(22) PCT Filed: Dec. 2, 2016
(86) PCT No.: PCT/US16/64579

§ 371 Date: Jun. 1, 2018

Related U.S. Application Data
(60) Provisional application No. 62/261,972, filed on Dec. 2, 2015.
(60) Provisional application No. 62/281,968, filed on Jan. 22, 2016.

(51) Int. Cl. G08B 21/02; H04W 4/021; H04W 4/02

(52) U.S. Cl. CPC G08B 21/0266; H04W 4/023; H04W 4/021

(57) ABSTRACT

A method, computer program product, and computer system for receiving, at a computing device, a location of an object, wherein the object may be at least a portion of a wearable configured to be coupled to an article of clothing It may be determined that the object is outside a predetermined area. An alert that the object is outside the predetermined area may be received.

### RELATED CASES

This application claims the benefit of U.S. Provisional Application No. 62/261,972, filed on 2 Dec. 2015, and U.S. Provisional Application No. 62/281,968, filed on 22 Jan. 2016, the contents of which are all incorporated by reference.

### BACKGROUND

As a parent or guardian, for example, it may be desirable to keep track of children for whom they are responsible. For instance, even the most vigilant and responsible people may get distracted from time to time and lose track of a child under their care. The example may be exacerbated by those children with special needs that may be more prone to wandering. As another example, a child may get lost or even kidnapped when the child is not directly under the supervision of the parent (e.g., on a school field trip, visiting a friend, etc.). Some devices (e.g., smartphones) may have GPS tracking capabilities; however, smartphones may be easily lost and may not always be carried by the child.

### BRIEF SUMMARY OF DISCLOSURE

In one example implementation, a method, performed by one or more computing devices, may include but is not limited to receiving, at a computing device, a location of an object, wherein the object may be at least a portion of a wearable configured to be coupled to an article of clothing. It may be determined that the object is outside a predetermined area. An alert that the object is outside the predetermined area may be received.

One or more of the following example features may be included. Determining that the object is outside the predetermined area may include determining that the object is outside the predetermined area for a threshold duration of time. A second location of a second object may be received at the computing device, wherein the second object may be at least a portion of a second wearable configured to be coupled to a second article of clothing. The location of the object and the second location of the second object may be simultaneously displayed on the computing device. The predetermined area may include an area selected on a graphical user interface map on the computing device. The predetermined area may include a distance from a predetermined location. The predetermined area may include a distance from the computing device.

In another example implementation, a computing system may include one or more processors and one or more memories configured to perform operations that may include but are not limited to receiving a location of an object, wherein the object may be at least a portion of a wearable configured to be coupled to an article of clothing. It may be determined that the object is outside a predetermined area. An alert that the object is outside the predetermined area may be received.

One or more of the following example features may be included. Determining that the object is outside the predetermined area may include determining that the object is outside the predetermined area for a threshold duration of time. A second location of a second object may be received, wherein the second object may be at least a portion of a second wearable configured to be coupled to a second article of clothing. The location of the object and the second location of the second object may be simultaneously displayed on a computing device. The predetermined area may include an area selected on a graphical user interface map on a computing device. The predetermined area may include a distance from a predetermined location. The predetermined area may include a distance from a computing device.

In another example implementation, a computer program product may reside on a computer readable storage medium having a plurality of instructions stored thereon which, when executed across one or more processors, may cause at least a portion of the one or more processors to perform operations that may include but are not limited to receiving a location of an object, wherein the object may be at least a portion of a wearable configured to be coupled to an article of clothing. It may be determined that the object is outside a predetermined area. An alert that the object is outside the predetermined area may be received.

One or more of the following example features may be included. Determining that the object is outside the predetermined area may include determining that the object is outside the predetermined area for a threshold duration of time. A second location of a second object may be received, wherein the second object may be at least a portion of a second wearable configured to be coupled to a second article of clothing. The location of the object and the second location of the second object may be simultaneously displayed on a computing device. The predetermined area may include an area selected on a graphical user interface map on a computing device. The predetermined area may include a distance from a predetermined location. The predetermined area may include a distance from a computing device.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a tracker process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a tracker process according to one or more example implementations of the disclosure;

FIG. 4 is an example diagrammatic view of a screen image displayed by a tracker process according to one or more example implementations of the disclosure;

FIG. 5 is an example diagrammatic view of a screen image displayed by a tracker process according to one or more example implementations of the disclosure;

FIG. 6 is an example diagrammatic view of a screen image displayed by a tracker process according to one or more example implementations of the disclosure; and

FIG. 7 is an example diagrammatic view of a screen image displayed by a tracker process according to one or more example implementations of the disclosure.

Like reference symbols in the various drawings indicate like elements.

### DETAILED DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

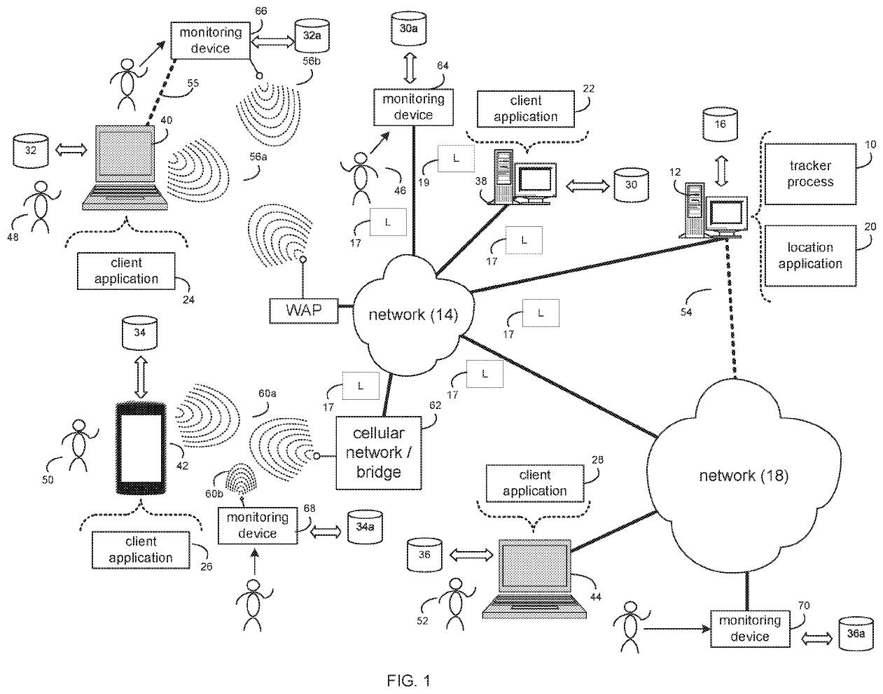

Referring now to the example implementation of FIG. 1, there is shown tracker process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a tracker process, such as tracker process 10 of FIG. 1, may receive, at a computing device, a location of an object, wherein the object may be at least a portion of a wearable configured to be coupled to an article of clothing. It may be determined that the object is outside a predetermined area. An alert that the object is outside the predetermined area may be received.

In some implementations, the instruction sets and subroutines of tracker process 10, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, tracker process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a location application (e.g., location application 20), examples of which may include, but are not limited to, e.g., a Global Positioning System (GPS) application, a map application, a navigation providing application, or other application that allows for the remote location identification of an object. In some implementations, tracker process 10 and/or location application 20 may be accessed via one or more of client applications 22, 24, 26, 28. In some implementations, tracker process 10 may be a standalone application, or may be an applet/application/script/extension that may interact with and/or be executed within location application 20, a component of location application 20, and/or one or more of client applications 22, 24, 26, 28. In some implementations, location application 20 may be a standalone application, or may be an applet/application/script/extension that may interact with and/or be executed within tracker process 10, a component of tracker process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of tracker process 10 and/or location application 20. Examples of client applications 22, 24, 26, 28 may include, but are not limited to, e.g., a Global Positioning System (GPS) application, a map application, a direction providing application, or other application that allows for the remote location identification of an object, a monitoring device, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, 30a, 32a, 34a, 36a, coupled to client electronic devices 38, 40, 42, 44 and/or monitoring devices 64, 66, 68, 70, may be executed by one or more processors and one or more memory architectures incorporated into client electronic devices 38, 40, 42, 44 and/or monitoring devices 64, 66, 68, 70.

In some implementations, one or more of storage devices 30, 32, 34, 36, 30a, 32a, 34a, 36a, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device, and a dedicated network device (not shown). Additionally/alternatively, one or more of client electronic devices 38, 40, 42, 44 may include a monitoring device (e.g., monitoring devices 64, 66, 68, 70). Client electronic devices 38, 40, 42, 44 may each execute an operating system, examples of which may include but are not limited to, Android™, Apple® iOS®, Mac® OS X®; Red Hat® Linux®, or a custom operating system.

In some implementations, one or more of client applications 22, 24, 26, 28 (and/or one or more of monitoring devices 64, 66, 68, 70) may be configured to effectuate some or all of the functionality of tracker process 10 (and vice versa). Accordingly, in some implementations, tracker process 10 may be a purely server-side application, a purely client-side application, or a hybrid server-side/client-side application that is cooperatively executed by one or more of client applications 22, 24, 26, 28 and/or tracker process 10 and/or one or more of monitoring devices 64, 66, 68, 70.

In some implementations, one or more of client applications 22, 24, 26, 28 (and/or one or more of monitoring devices 64, 66, 68, 70) may be configured to effectuate some or all of the functionality of location application 20 (and vice versa). Accordingly, in some implementations, location application 20 may be a purely server-side application, a purely client-side application, or a hybrid server-side/client-side application that is cooperatively executed by one or more of client applications 22, 24, 26, 28 and/or location application 20 (and/or one or more of monitoring devices 64, 66, 68, 70). As one or more of client applications 22, 24, 26, 28, tracker process 10, and/or location application 20 (and/or one or more of monitoring devices 64, 66, 68, 70), taken singly or in any combination, may effectuate some or all of the same functionality, any description of effectuating such functionality via one or more of client applications 22, 24, 26, 28, tracker process 10, location application 20, (and/or one or more of monitoring devices 64, 66, 68, 70) or combination thereof, and any described interaction(s) between one or more of client applications 22, 24, 26, 28, tracker process 10, location application 20, (and/or one or more of monitoring devices 64, 66, 68, 70) or combination thereof to effectuate such functionality, should be taken as an example only and not to limit the scope of the disclosure.

In some implementations, one or more of users 46, 48, 50, 52 and/or one or more of monitoring devices 64, 66, 68, 70 may access computer 12 and tracker process 10 (e.g., using one or more of client electronic devices 38, 40, 42, 44) directly through network 14 or through secondary network 18. Further, computer 12 may be connected to network 14 through secondary network 18, as illustrated with phantom link line 54. Tracker process 10 may include one or more user interfaces, such as browsers and textual or graphical user interfaces, through which users 46, 48, 50, 52 may access tracker process 10 and/or monitoring devices 64, 66, 68, 70.

In some implementations, one or more of the various client electronic devices and/or one or more of monitoring devices 64, 66, 68, 70 may be directly or indirectly coupled to network 14 (or network 18). For example, personal computer 38 and monitoring device 64 are shown directly coupled to network 14 via a hardwired network connection. Further, notebook computer 44 and monitoring device 70 are shown directly coupled to network 18 via a hardwired network connection. Laptop computer 40 and monitoring device 66 are shown wirelessly coupled to network 14 via wireless communication channels 56a and 56b respectively established between laptop computer 40 and wireless access point (i.e., WAP) 58 and between monitoring device 66 and WAP 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56a between laptop computer 40 and WAP 58 and wireless communication channel 56b between DEVICE 66 and WAP 58. Additionally/alternatively, a monitoring device (e.g., monitoring device 66) may be directly (and/or wirelessly) coupled to a client electronic device (e.g., client electronic device 40) as illustrated with phantom link line 55. Thus, information may be communicated from a monitoring device (e.g., monitoring device 66) to a client electronic device (e.g., client electronic device 40), where the information may be communicated, e.g., to computer 12 via, e.g., a network (e.g., network 14). Smart phone 42 and monitoring device 68 are shown wirelessly coupled to network 14 via wireless communication channels 60a and 60b respectively established between smart phone 42 and cellular network/bridge 62 and monitoring device 68 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices (e.g., monitoring devices 64, 66, 68, 70) to be interconnected using a short-range wireless connection. Other forms of interconnection (e.g., Near Field Communication (NFC)) may also be used. In some implementations, monitoring devices 64, 66, 68, 70 may be capable of wirelessly providing their location to the above-noted client electronic devices and/or computer 12 using known methods, e.g., GPS, RFID, Bluetooth™ (including Bluetooth™ Low Energy), etc., or any of the other methods described throughout.

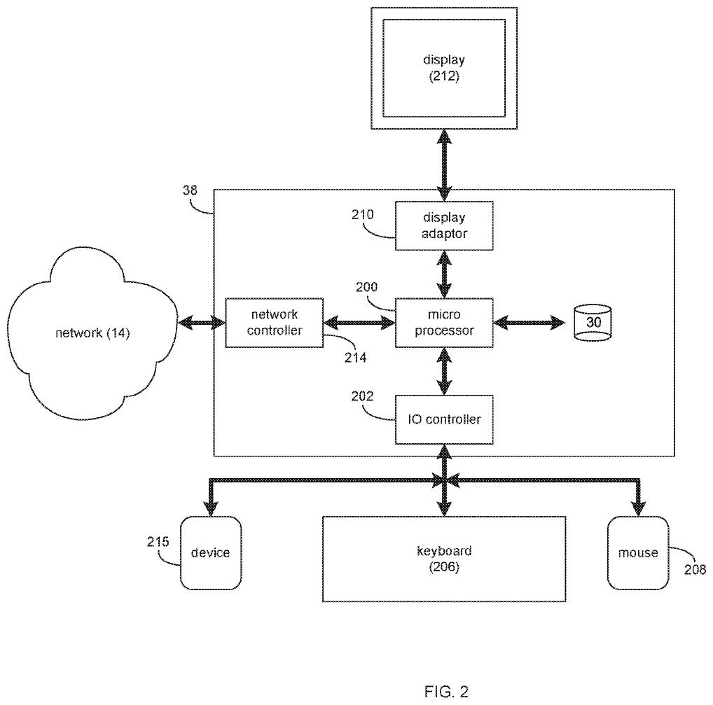

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, tracker process 10 may be substituted for client electronic device 38 (in whole or in part) within FIG. 2, examples of which may include but are not limited to computer 12 and/or one or more of client electronic devices 38, 40, 42, 44 and/or one or more of monitoring devices 64, 66, 68, 70.

In some implementations, client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

### The Tracker Process

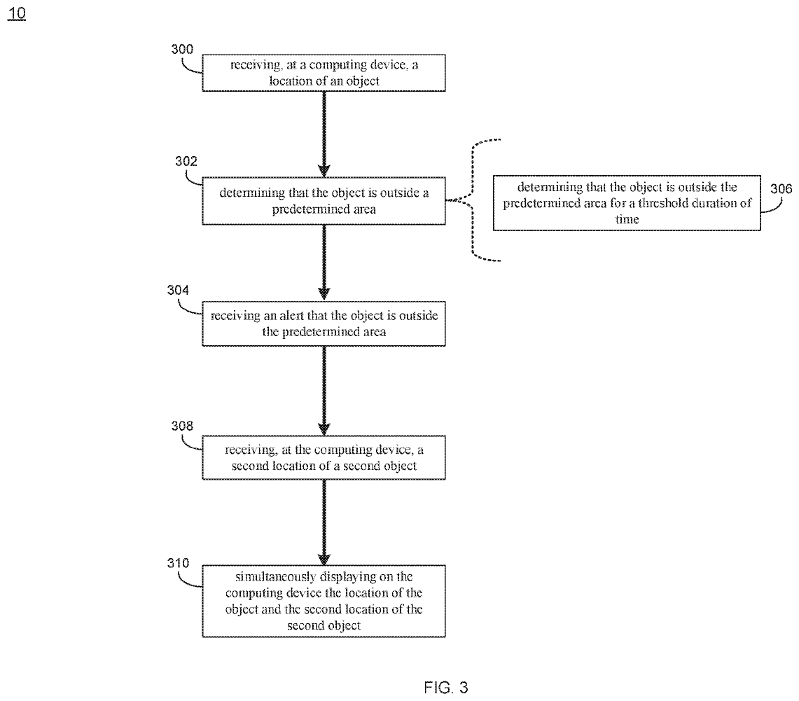

As discussed above and referring also at least to the example implementations of FIGS. 3-7, tracker process 10 may receive, at a computing device, a location of an object, wherein the object may be at least a portion of a wearable configured to be coupled to an article of clothing. Tracker process 10 may determine that the object is outside a predetermined area. Tracker process 10 may receive an alert that the object is outside the predetermined area.

As a parent or guardian, for example, it may be desirable to keep track of children for whom they are responsible. For instance, even the most vigilant and responsible people may get distracted from time to time and lose track of a child under their care. The example may be exacerbated by those children with special needs that may be more prone to wandering. As another example, a child may get lost or even kidnapped when the child is not directly under the supervision of the parent (e.g., on a school field trip, visiting a friend, etc.). Some devices (e.g., smartphones) may have GPS tracking capabilities; however, smartphones may be easily lost and may not always be carried by the child.

In some implementations, tracker process 10 may receive 300, at a computing device, a location of an object, wherein the object may be at least a portion of a wearable configured to be coupled to an article of clothing. For instance, assume for example purposes only that a parent (e.g., user 50) wants to know the whereabouts of their child, and as such has given their child a so-called “wearable.” As used herein, a wearable may include any object (e.g., monitoring device/beacon) capable of electronically providing its location using any known techniques such as those discussed throughout (e.g., GPS, RFID, Bluetooth™, etc.), where the object may be directly coupled to an article of clothing or accessory (e.g., backpack, footwear, shirt, sweater, pants, dress, socks, watch, necklace, ring, or other jewelry, etc.). In some implementations, the object may be directly coupled to the article of clothing by being embedded or integrated within the article of clothing (e.g., within the sole of a shoe, within the lining of a backpack, within the material of the shirt, etc.). In some implementations, the object may be indirectly coupled to the article of clothing by using fastening techniques (e.g., hook and loop, safety pin, carabiner, adhesive, etc.). It will be appreciated that other examples of wearables and coupling techniques may be used without departing from the scope of the disclosure.

Continuing with the above example, the object (e.g., monitoring device 68) may send its location (e.g., location 17 in FIG. 1) to be received 300 by, e.g., the computing device of user 50 (e.g., client electronic device 42 via tracker process 10). For instance, monitoring device 68 may send its location 17 to be received 300 by client electronic device 42 during predetermined intervals (e.g., every 15 seconds). As another example, client electronic device 42 (e.g., via tracker process 10) may periodically send location requests that may be received by monitoring device 68 to send its location to be received 300 by client electronic device 42. It will be appreciated that other techniques and/or interval schemes may be used to receive 300 location 17 of monitoring device 68 without departing from the scope of the disclosure.

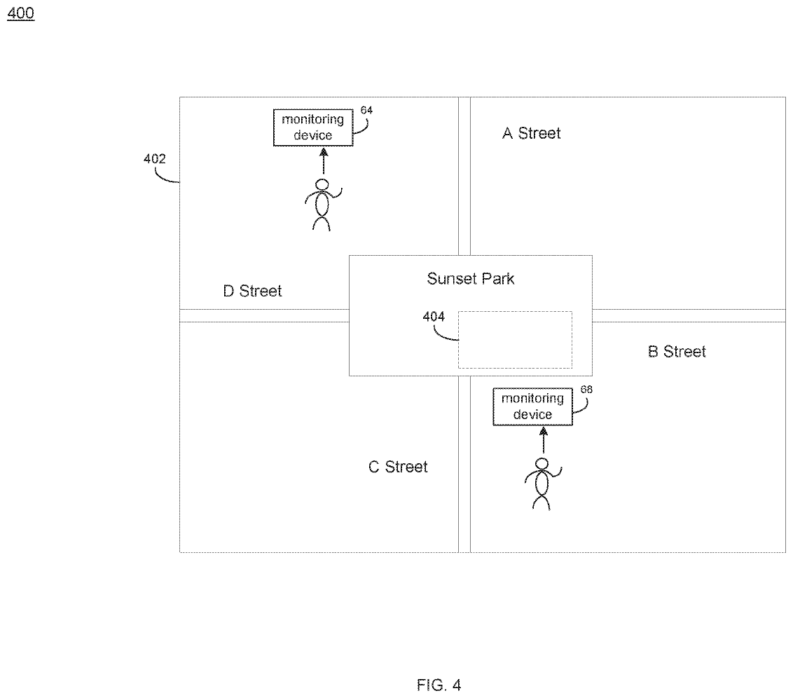

In some implementations, tracker process 10 may determine 302 that the object is outside a predetermined area. For instance, and referring at least to the example implementation of FIG. 4, an example user interface (e.g., UI 400) that may be part of tracker process 10 on client electronic device 42 is shown. In the example, tracker process 10 (e.g., via UI 400) may enable user 50 to set a predetermined area. For instance, in some implementations, the predetermined area may include an area selected on a graphical user interface map on the computing device. For example, UI 400 may include a map display (e.g., map 402). Tracker process 10 may (e.g., via UI 400) enable user 50 to select a predetermined area (e.g., predetermined area 404) using, e.g., a finger on a touchscreen, mouse, other pointing device, manually entered boundaries, etc.). Further in the example, assume that monitoring device 68 is outside of predetermined area 404. In the example, upon receiving 300 location 17 of monitoring device 68 (e.g., from monitoring device 68 or from another computing device that first received location 17 to then be sent to client electronic device 42), tracker process 10 may compare the location of each (e.g., location 17 and predetermined area 404) and determine 302 that location 17 is not within predetermined area 404, and therefore monitoring device 68 is outside predetermined area 404. As such, it may be inferred that the child wearing monitoring device 68 is outside predetermined area 404.

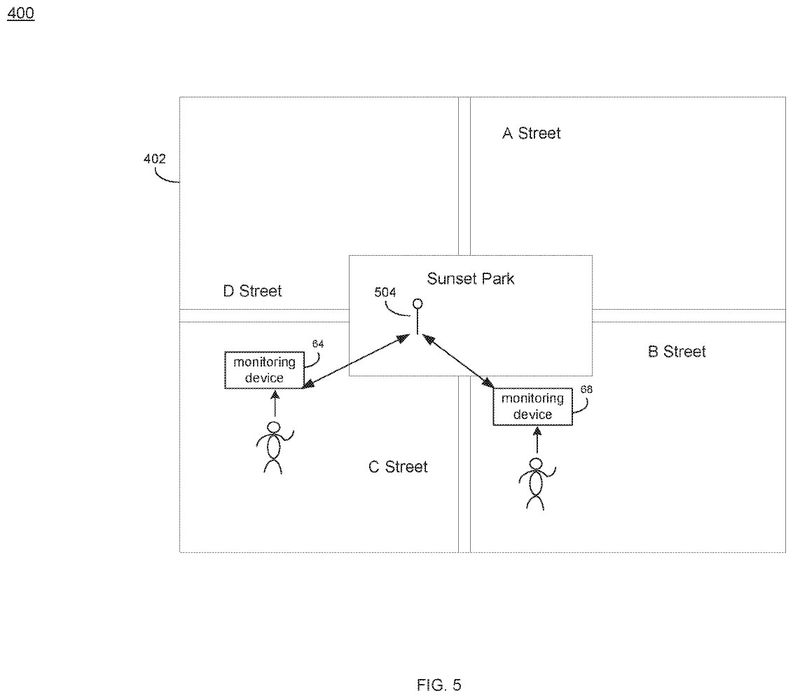

In some implementations, the predetermined area may include a distance from a predetermined location. For instance, and referring at least to the example implementation of FIG. 5, tracker process 10 may (e.g., via UI 400) enable user 50 to select a location (e.g., noted via location pin 504) on map 402 using, e.g., a finger on a touchscreen, mouse, manual entry via a keyboard, other pointing device, etc.). In the example, the predetermined area may be a predetermined distance (e.g., radius/circumference) of monitoring device 68 from location pin 504. Further in the example, assume that user 50 (e.g., via UI 400) has set the predetermined distance between monitoring device 68 and location pin 504 at, e.g., 25 feet. Further assume that monitoring device 68 is 26 feet away from location pin 504. In the example, upon receiving 300 location 17 of monitoring device 68, tracker process 10 may compare the location of each (e.g., location 17 and location pin 504) and determine 302 that location 17 is not within 25 feet of location pin 504, and therefore monitoring device 68 is not within 25 feet of location pin 504 (i.e., outside the predetermined area). As such, it may be inferred that the child wearing monitoring device 68 is not within 25 feet of location pin 504 (i.e., outside the predetermined area).

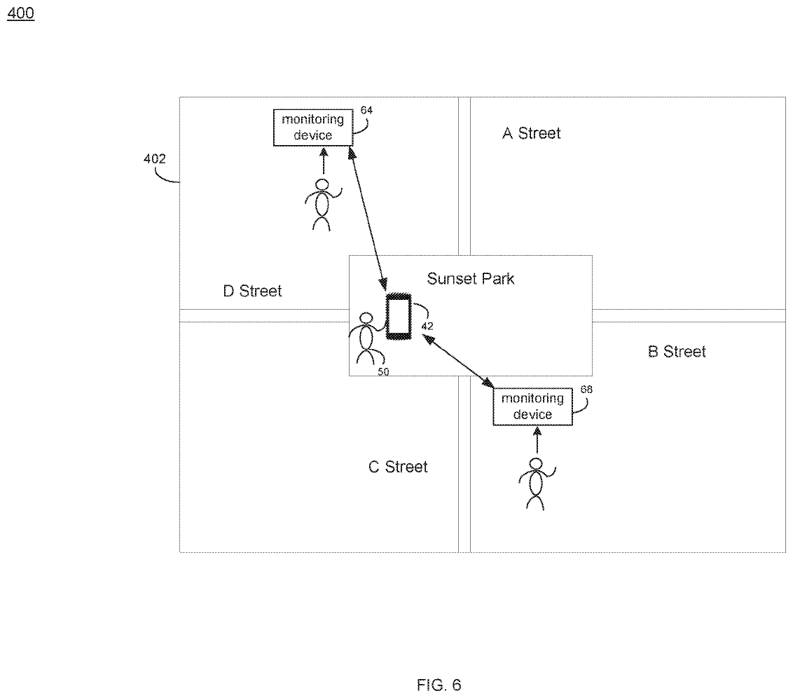

In some implementations, the predetermined area may include a distance from the computing device. For instance, and referring at least to the example implementation of FIG. 6, tracker process 10 may (e.g., via UI 400) enable user 50 to select as the predetermined area a predetermined distance (e.g., radius/circumference) from the location of client electronic device 42 using, e.g., a finger on a touchscreen, mouse, manual entry via a keyboard, other pointing device, etc.). In the example, the location of both client electronic device 42 and monitoring device 68 are shown on map 402. Thus, in the example, the predetermined area may be a predetermined distance of monitoring device 68 from the location of client electronic device 42. Further in the example, assume that user 50 (e.g., via US 400) has set the predetermined distance between monitoring device 68 and the location of client electronic device 42 at, e.g., 10 feet, and that client electronic device 42 has the ability to determine its own location (e.g., using GPS or other known technique). Further assume that monitoring device 68 is 15 feet away from the location of client electronic device 42. In the example, upon receiving 300 location 17 of monitoring device 68, tracker process 10 may compare the location of each (e.g., location 17 and client electronic device 42) and determine 302 that location 17 is not within 15 feet of client electronic device 42, and therefore monitoring device 68 is not within 15 feet of client electronic device 42 (i.e., outside the predetermined area). As such, it may be inferred that the child wearing monitoring device 68 is not within 15 feet of client electronic device 42 (i.e., outside the predetermined area).

In some implementations, tracker process 10 may receive 304 an alert that the object is outside the predetermined area. For instance, and referring again to FIG. 4, assume for example tracker process 10 determines 302 that location 17 (and therefore monitoring device 68 and the user coupled to monitoring device 68) is not within (i.e., outside) predetermined area 404. In the example, tracker process 10 (e.g., via client electronic device 42) may receive 304 an alert that monitoring device 68 (and therefore the user coupled to monitoring device 68) is not within predetermined area 404. The alert may be, e.g., text message, audio sound, vibration of client electronic device 42, email, automated phone message, or other alert that may make user 50 aware that monitoring device 68 (and therefore the user coupled to monitoring device 68) is not within predetermined area 404. In some implementations, the received 304 alert may be internally generated by client electronic device 42 (e.g., via tracker process 10). In some implementations, the received 304 alert may be generated elsewhere (e.g., via monitoring device 68 or other computing device) and sent to client electronic device 42 to be received 304 by tracker process 10. Thus, in some implementations, monitoring device 68 (e.g., via tracker process 10) may be used as a “virtual leash” for the user coupled to monitoring device 68.

As another example, and referring again to FIG. 5, assume for example tracker process 10 determines 302 that monitoring device 68 (and therefore monitoring device 68 and the user coupled to monitoring device 68) is not within (i.e., outside) 25 feet of location pin 504 and thus not within the predetermined area. In the example, tracker process 10 (e.g., via client electronic device 42) may receive 304 an alert that monitoring device 68 (and therefore the user coupled to monitoring device 68) is not within 25 feet of location pin 504 and thus not within the predetermined area.

As yet another example, and referring again to FIG. 6, assume for example tracker process 10 determines 302 that monitoring device 68 (and therefore monitoring device 68 and the user coupled to monitoring device 68) is not within (i.e., outside) 15 feet of client electronic device 42 and thus not within the predetermined area. In the example, tracker process 10 (e.g., via client electronic device 42) may receive 304 an alert that monitoring device 68 (and therefore the user coupled to monitoring device 68) is not within 15 feet of client electronic device 42 and thus not within the predetermined area.

In some implementations, determining 302 that the object is outside the predetermined area may include tracker process 10 determining 306 that the object is outside the predetermined area for a threshold duration of time. For instance, and referring again to FIG. 4, assume for example tracker process 10 determines 302 that location 17 (and therefore monitoring device 68 and the user coupled to monitoring device 68) is not within (i.e., outside) predetermined area 404. Further assume that tracker process 10 (e.g., via UI 400) enables user 50 to set a threshold duration of time (e.g., 5 seconds) during which monitoring device 68 may be outside the predetermined area before determining 302 that monitoring device 68 is outside the predetermined area. Further assume that tracker process 10 determines 306 that monitoring device 68 is outside the predetermined area for 6 seconds. In the example, based upon tracker process 10 determining 306 that monitoring device 68 is outside the predetermined area beyond the 5 second threshold, tracker process 10 (e.g., via client electronic device 42) may determine 302 that monitoring device 68 (and therefore the user coupled to monitoring device 68) is not within predetermined area 404, whereby the above-noted alert may be received 304. Conversely, assume instead that tracker process 10 determines 306 that monitoring device 68 is outside the predetermined area for 4 seconds before reentering predetermined area 404. In the example, based upon tracker process 10 determining 306 that monitoring device 68 is outside the predetermined area for less than the 5 second threshold, tracker process 10 (e.g., via client electronic device 42) may determine 302 that monitoring device 68 (and therefore the user coupled to monitoring device 68) is still within predetermined area 404, whereby the above-noted alert may not be received 304. In some implementations, this may prevent “false alerts” when the user coupled to monitoring device 68 is remaining at and/or continuously moving in and out of the edge of predetermined area, but still predominantly within predetermined area 404.

It will be appreciated that the threshold duration of time (e.g., 5 seconds) during which monitoring device 68 may be outside the predetermined area before determining 302 that monitoring device 68 is outside the predetermined area does not necessarily mean that tracker process 10 is not aware that monitoring device 68 may be physically (in real-time) outside the predetermined area based upon the location information.

As another example, and referring again to FIG. 5, assume for example tracker process 10 determines 302 that monitoring device 68 (and therefore monitoring device 68 and the user coupled to monitoring device 68) is not within 25 feet of location pin 504 and thus not within the predetermined area. Further assume that tracker process 10 (e.g., via UI 400) enables user 50 to set a threshold duration of time (e.g., 5 seconds) during which monitoring device 68 may be outside the predetermined area before determining 302 that monitoring device 68 is outside the predetermined area. Further assume that tracker process 10 determines 302 that monitoring device 68 is 26 feet away from location pin 504 for 6 seconds. In the example, based upon tracker process 10 determining 306 that monitoring device 68 is 26 feet away from location pin 504 beyond the 5 second threshold, tracker process 10 (e.g., via client electronic device 42) may determine 302 that monitoring device 68 (and therefore the user coupled to monitoring device 68) is not within 25 feet of location pin 504, whereby the above-noted alert may be received 304. Conversely, assume instead that tracker process 10 determines 306 that monitoring device 68 is not within 25 feet of location pin 504 for 4 seconds before reentering a distance within 25 feet of location pin 504. In the example, based upon tracker process 10 determining 306 that monitoring device 68 is not within 25 feet of location pin 504 for less than the 5 second threshold, tracker process 10 (e.g., via client electronic device 42) may determine 302 that monitoring device 68 (and therefore the user coupled to monitoring device 68) is still within 25 feet of location pin 504, whereby the above-noted alert may not be received 304. In some implementations, this may prevent “false alerts” when the user coupled to monitoring device 68 is remaining at the edge of the 25 foot distance and/or continuously moving in and out of the 25 foot distance, but still predominantly within predetermined distance (e.g., predetermined area) of 25 feet.

As another example, and referring again to FIG. 6, assume for example tracker process 10 determines 302 that monitoring device 68 (and therefore monitoring device 68 and the user coupled to monitoring device 68) is not within 15 feet of client electronic device 42 and thus not within the predetermined area. Further assume that tracker process 10 (e.g., via UI 400) enables user 50 to set a threshold duration of time (e.g., 5 seconds) during which monitoring device 68 may be outside the predetermined area before determining 302 that monitoring device 68 is outside the predetermined area. Further assume that tracker process 10 determines 306 that monitoring device 68 is 16 feet away from client electronic device 42 for 6 seconds. In the example, based upon tracker process 10 determining 306 that monitoring device 68 is 16 feet away from client electronic device 42 beyond the 5 second threshold, tracker process 10 (e.g., via client electronic device 42) may determine 302 that monitoring device 68 (and therefore the user coupled to monitoring device 68) is not within 15 feet of client electronic device 42, whereby the above-noted alert may be received 304. Conversely, assume instead that tracker process 10 determines 306 that monitoring device 68 is not within 15 feet of client electronic device 42 for 4 seconds before reentering a distance within 15 feet of client electronic device 42. In the example, based upon tracker process 10 determining 306 that monitoring device 68 is not within 15 feet of client electronic device 42 for less than the 5 second threshold, tracker process 10 (e.g., via client electronic device 42) may determine 302 that monitoring device 68 (and therefore the user coupled to monitoring device 68) is still within 15 feet of client electronic device 42, whereby the above-noted alert may not be received 304. In some implementations, this may prevent “false alerts” when the user coupled to monitoring device 68 is remaining at the edge of the 15 foot distance and/or continuously moving in and out of the 15 foot distance, but still predominantly within predetermined distance (e.g., predetermined area) of 15 feet.

In some implementations, a second location of a second object may be received 308 at the computing device by tracker process 10, wherein the second object may be at least a portion of a second wearable configured to be coupled to a second article of clothing. For instance, assume for example purposes only that a parent (e.g., user 50) wants to know the whereabouts of their second child, and like the child in the above example, has given the second child a monitoring device (e.g., monitoring device 64). Continuing with the example, like monitoring device 68, the object (e.g., monitoring device 64) may send its location (e.g., location 19 in FIG. 1) to be received 300 by, e.g., the computing device of user 50 (e.g., client electronic device 42 via tracker process 10). For instance, monitoring device 64 may periodically (e.g., every 15 seconds) send its location 19 to be received 300 by client electronic device 42 during predetermined intervals. As another example, client electronic device 42 (e.g., via tracker process 10) may periodically send location requests that may be received by monitoring device 64 to send its location to be received 300 by client electronic device 42.

In some implementations, the location of the object and the second location of the second object may be simultaneously displayed 310 on the computing device by tracker process 10. For example, and referring again at least to FIGS. 4-6, UI 400 may include a map display (e.g., map 402), that may simultaneously display 310 the locations of monitoring device 68 and monitoring device 64. Thus, in the example, user 50 (e.g., via tracker process 10 and client electronic device 50) may be able to simultaneously view and monitor the users coupled to monitoring device 64 and 68. It will be appreciated that any number of monitoring devices may be used without departing from the scope of the disclosure. As such, the description of one or two monitoring devices should be taken as example only and not to otherwise limit the scope of the disclosure.

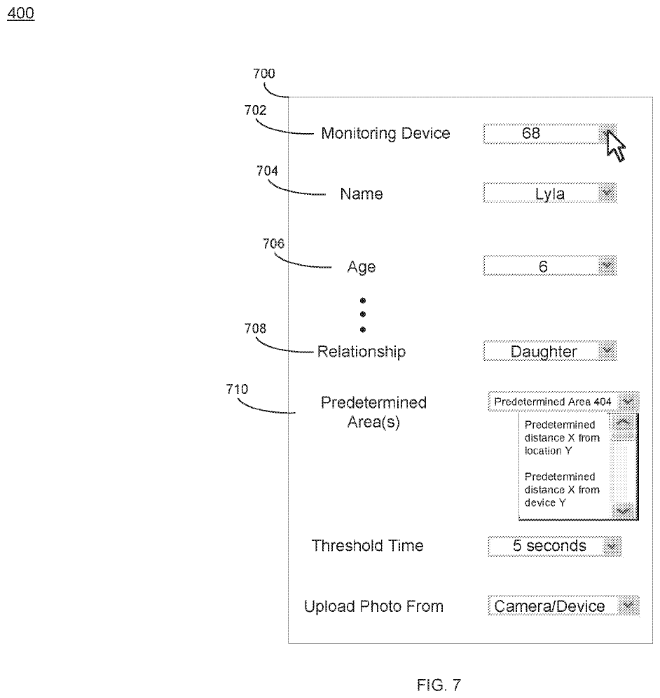

In some implementations, and referring at least to FIG. 7, UI 400 may enable user 50 to personalize each monitoring device. For instance, UI 400 may include a field entry display (e.g., display 700) enabling user 50 to enter information pertaining to the user coupled to the respective monitoring device. For example, using known techniques for data entry, data field 702 of display 700 may enable user 50 to select the monitoring device with which to associate the data. Similarly, data field 704 of display 700 may enable user 50 to enter the name (e.g., of the child) coupled to, e.g., monitoring device 68. Similarly, data field 706 of display 700 may enable user 50 to enter the age (e.g., of the child) coupled to, e.g., monitoring device 68. Similarly, data field 708 of display 700 may enable user 50 to enter the relationship (e.g., of the child) coupled to, e.g., monitoring device 68, which may include, e.g., daughter, son, etc. It will be appreciated that other data fields (e.g., image upload of the child), as well as varying numbers of data fields, may be used without departing from the scope of the disclosure. In some implementations, the information entered into the data fields may be displayed on map 402 by tracker process 10 (e.g., automatically, via hovering a cursor over the monitoring device, or selecting the monitoring device) to help user 50 identify on map 402 which child is associated with which monitoring device.

It will be appreciated that more than one predetermined area may be selected at a given time. For example, tracker process 10 may (e.g., via UI 400) enable user 50 to select predetermined area 404 and a second predetermined area (not shown) that may be simultaneously monitored with regard to the monitoring devices. In some implementations, tracker process 10 (e.g., via client electronic device 42) may receive 304 an alert that monitoring device 68 (and therefore the user coupled to monitoring device 68) is not within predetermined area 404, and that monitoring device 64 (and therefore the user coupled to monitoring device 64) is not within the second predetermined area (similarly as with monitoring device 68). In some implementations, another data field 710 of display 700 may enable user 50 to enter the desired predetermined area to be monitored with one or more monitoring devices (e.g., monitoring device 68 and/or monitoring device 64).

It will be appreciated that while tracker process 10 may receive 304 alerts when monitoring device 68 is outside of a predetermined area, tracker process 10 may similarly use the location of monitoring device 68 to receive alerts when monitoring device 68 is within the predetermined area (or has entered/reentered the predetermined area). As such, the description of providing alerts when monitoring device 68 is outside the predetermined area should be taken as example only and not to otherwise limit the scope of the disclosure.

In some implementations, monitoring device 68 may include vital sign sensors or other sensors (e.g., accelerometer, gyro, micro USB charging port, SIM card, etc.). In some implementations, the information obtained from the sensors may be provided to client electronic device 42 (e.g., via tracker process 10). In some implementations, the information may be displayed in map 402 or otherwise via UI 400.

While the disclosure involves wearables for humans, it will be appreciated that wearables may also be used for pets without departing from the scope of the disclosure. For example, the monitoring device may be coupled to the pet's collar, clothing, or elsewhere. It will also be appreciated that wearables may also be used for personal items (e.g., purses, computing devices, bicycles, E-readers, briefcases, Mp3 players, etc.).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, at a computing device, a location of an object, wherein the object is at least a portion of a wearable configured to be coupled to an article of clothing;
determining that the object is outside a predetermined area; and
receiving an alert that the object is outside the predetermined area.

2. The computer-implemented method of claim 1 wherein determining that the object is outside the predetermined area includes determining that the object is outside the predetermined area for a threshold duration of time.

3. The computer-implemented method of claim 1 further comprising receiving, at the computing device, a second location of a second object, wherein the second object is at least a portion of a second wearable configured to be coupled to a second article of clothing.

4. The computer-implemented method of claim 3 further comprising simultaneously displaying on the computing device the location of the object and the second location of the second object.

5. The computer-implemented method of claim 1 wherein the predetermined area includes an area selected on a graphical user interface map on the computing device.

6. The computer-implemented method of claim 1 wherein the predetermined area includes a distance from a predetermined location.

7. The computer-implemented method of claim 1 wherein the predetermined area includes a distance from the computing device.

8. A computer program product residing on a computer readable storage medium having a plurality of instructions stored thereon which, when executed across one or more processors, causes at least a portion of the one or more processors to perform operations comprising:
receiving a location of an object, wherein the object is at least a portion of a wearable configured to be coupled to an article of clothing;
determining that the object is outside a predetermined area; and
receiving an alert that the object is outside the predetermined area.

9. The computer program product of claim 8 wherein determining that the object is outside the predetermined area includes determining that the object is outside the predetermined area for a threshold duration of time.

10. The computer program product of claim 8 further comprising receiving a second location of a second object, wherein the second object is at least a portion of a second wearable configured to be coupled to a second article of clothing.

11. The computer program product of claim 10 further comprising simultaneously displaying on a computing device the location of the object and the second location of the second object.

12. The computer program product of claim 8 wherein the predetermined area includes an area selected on a graphical user interface map on a computing device.

13. The computer program product of claim 8 wherein the predetermined area includes a distance from a predetermined location.

14. The computer program product of claim 8 wherein the predetermined area includes a distance from a computing device.

15. A computing system including one or more processors and one or more memories configured to perform operations comprising:
receiving a location of an object, wherein the object is at least a portion of a wearable configured to be coupled to an article of clothing;
determining that the object is outside a predetermined area; and
receiving an alert that the object is outside the predetermined area.

16. The computing system of claim 15 wherein determining that the object is outside the predetermined area includes determining that the object is outside the predetermined area for a threshold duration of time.

17. The computing system of claim 15 further comprising receiving a second location of a second object, wherein the second object is at least a portion of a second wearable configured to be coupled to a second article of clothing.

18. The computing system of claim 17 further comprising simultaneously displaying on a computing device the location of the object and the second location of the second object.

19. The computing system of claim 15 wherein the predetermined area includes an area selected on a graphical user interface map on a computing device.

20. The computing system of claim 15 wherein the predetermined area includes a distance from a predetermined location.

21. The computing system of claim 15 wherein the predetermined area includes a distance from a computing device.
